(19) United States
(12) Patent Application Publication
(10) Pub. No.: US 2014/0304626 A1
(43) Pub. Date: Oct. 9, 2014

(54) METHOD AND CLIENT DEVICE FOR DISPLAYING A PAGE HEADER

(71) Applicant: Alibaba Group Holding Limited, Grand Cayman (KY)

(72) Inventor: Ding Sheng, Hangzhou (CN)

(73) Assignee: Alibaba Group Holding Limited, Grand Cayman (KY)

(21) Appl. No.: 14/243,229

(22) Filed: Apr. 2, 2014

(30) Foreign Application Priority Data
Apr. 3, 2013 (CN) 201310114432.0

(51) Int. Cl. G06F 3/0485

(52) U.S. Cl. CPC G06F 3/0485
USPC 715/760

(57) ABSTRACT

A method and a client device for displaying a page header are provided. The method includes: when a page header is to be displayed, determining whether a current page is an information display page or an information detail page, and determining a status of the current page; when the current page is the information display page and is in a browsing status, displaying the page header according to configuration information if the page header does not include a navigation bar; and when the current page is the information detail page and is in the browsing status, displaying the page header according to the configuration information. The present disclosure is able to adjust a page header accordingly in response to different real scenarios.

### CROSS REFERENCE TO RELATED PATENT APPLICATION

This application claims foreign priority to Chinese Patent Application No. 201310114432.0 filed on Apr. 3, 2013, entitled “Method and Client Device of Displaying a Page Header”, which is hereby incorporated by reference in its entirety.

### TECHNICAL FIELD

The present disclosure relates to a networking field, and more particularly, relates to methods and client devices for displaying a page header.

### BACKGROUND

A page header includes a header of a page, and a header of an application program of a mobile device. The design of a page header and the integration of the page header with the entire page can affect the perception and impression of the page to a user, and sometimes can even serve navigation functionality. A page header plays a very important role in page design so to speak. However, existing headers in client applications and pages are fixed and cannot be configured by users. They fail to achieve a true integration with the pages and fail to adjust according to changes in user application scenarios, and thus their capacities have not yet been fully explored.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

A technical problem to be solved by the present disclosure is how to adjust a page header according to differences in real situations.

In order to solve the aforementioned problem, the present disclosure provides a method of displaying a page header, which includes:

when a page header is to be displayed, determining whether a current page is an information display page or an information detail page, and determining a status of the current page;

when the current page is the information display page and is in a browsing status, displaying the page header according to configuration information if the page header does not include a navigation bar; and

when the current page is the information detail page and is in the browsing status, displaying the page header according to the configuration information.

Furthermore, the configuration information includes one or any combination of the following attribute information of the page header: a height, a color and a style.

The method further includes:

adjusting the configuration information based on content or a domain name of the current page using a predetermined correspondence relationship.

Moreover, the method further includes:

displaying a page header having only a title bar when the current page is the information display page and is in either a modal status or a scrolling status; and

displaying the page header having only the title bar when the current page is the information detail page and is in either an editing status or the scrolling status.

Furthermore, the method also includes:

when the current page is the information display page and is in the browsing status, displaying a page header having a navigation function if the page header includes a navigation bar.

Moreover, the method further includes:

when the current page is switched from the browsing status to the modal status, the editing status or the scrolling status, hiding the navigation bar and switching to display the page header having only the title bar if an originally displayed page header includes a navigation function, or ignoring the configuration information and switching to display the page header having only the title bar if the originally displayed page header has been displayed according to the configuration information;

when the current page is switched to the browsing status from another status, switching to display a page header having a navigating function if the current page is the information display page with a navigation bar provided, or switching to display a page header according to the configuration information if no navigation bar has been provided and the configuration information exists; if the current page is the information detail page, hiding a navigation bar and switching to display the page header according to the configuration information if the navigation bar and the configuration information exists, or switching to display a page header according to the configuration information if no navigation bar has been provided and the configuration information exists.

The present disclosure further provides a client device, which includes:

a display unit;

a determination unit used for, when a page header is to be displayed, determining whether a current page is an information display page or an information detail page, and determining a status of the current page; and

a control unit used for, when the current page is the information display page and is in a browsing status, instructing the display unit to display the page header according to configuration information when the page header does not include a navigation bar; when the current page is the information detail page and is in the browsing status, instructing the display unit to display the page header according to the configuration information.

Further, the configuration information includes any one or combination of attribute information of the page header: a height, a color and a style.

The client device further includes:

a configuration unit for adjusting the configuration information based on content or a domain name of the current page using a predetermined correspondence relationship.

Moreover, the control unit is further used for instructing the display unit to display a page header having only a title bar when the current page is the information display page and is in either a modal status or a scrolling status, or when the current page is the information detail page and is in either an editing status or the scrolling status.

Furthermore, the control unit is also used for, when the current page is the information display page and is in the browsing status, instructing the display unit to display a page header having a navigating function if the page header includes a navigation bar.

Furthermore, the control unit is further used for, when the current page is switched from the browsing status to the modal status, the editing status or the scrolling status, hiding the navigation bar and instructing the display unit to switch to display the page header having only the title bar if an originally displayed page header includes a navigation function, or ignoring the configuration information and instructing the display unit to switch to display the page header having only the title bar if the originally displayed page header has been displayed according to the configuration information; when the current page is switched to the browsing status from another status, instructing the display unit to switch to display the page header having the navigating function if the current page is the information display page with the navigation bar provided, or instructing the display unit to switch to display the page header according to the configuration information if no navigation bar has been provided and the configuration information exists; if the current page is the information detail page, hiding the navigation bar and instructing the display unit to switch to display the page header according to the configuration information if the navigation bar and the configuration information exists, or instructing the display unit to switch to display the page header according to the configuration information if no navigation bar has been provided and the configuration information exists.

Another embodiment of the present disclosure can provide a changeable and configurable page header to ensure not only characteristics and customization, but also universal applicability of a page. Another embodiment can actively change a page header to match page content according to differences in pages and applications, and in some applications, can serve essential functions (such as navigation, title, etc.) of the page header at the same time when combining with the content. Still another embodiment can adjust size, content and function of a page header based on page content in different scenarios (e.g., a browsing status, an editing status, or a page modal status, etc.). Nevertheless, any product that implements the present disclosure does not need to achieve all the above merits at the same time.

### BRIEF DESCRIPTION OF THE DRAWINGS

FIG. 1 is a schematic diagram illustrating respective page headers when a current page is an information display page/an information detail page in accordance with a first embodiment of the present disclosure.

FIG. 2 is a schematic diagram illustrating respective page headers when a current page is in different statuses in accordance with the first embodiment of the present disclosure.

FIG. 3 is a structural diagram illustrating a page header displayed in the first embodiment of the present disclosure.

FIG. 4 is a schematic diagram illustrating different types of page headers in the first embodiment of the present disclosure.

FIG. 5 is a flowchart illustrating a process of creating different types of page headers in the first embodiment of the present disclosure.

FIG. 6 is a structural diagram illustrating a client device in a second embodiment of the present disclosure.

FIG. 7 is a structural diagram illustrating the example client device in FIG. 6 in more detail.

### DETAILED DESCRIPTION

The technical scheme of the present disclosure will be described in further detail below using the accompanying figures and embodiments.

It should be noted that the embodiments and features of the embodiments of the present disclosure can be combined with each other and are within the scope of the present disclosure if no conflict exists therebetween. In addition, although the flowchart demonstrates a logical order, blocks that are shown or described therein can be executed in different orders under certain situations.

In a first embodiment, a method of displaying a page header includes:

when a page header is to be displayed, determining whether a current page is an information display page or an information detail page, and determining a status of the current page;

when the current page is the information display page and is in a browsing status, displaying the page header according to configuration information if the page header does not include a navigation bar; and

when the current page is the information detail page and is in the browsing status, displaying the page header according to the configuration information.

An information display page has a browsing status, a scrolling status or a modal status. An information detail page has a browsing status, a scrolling status or an editing status. The modal status refers to a status of a page used for processing a specific matter. A modal control of the page header is to be displayed while the page entering into the modal status (a navigation bar does not include a modal control).

In this embodiment, the configuration information includes any one or combination of the following attribute information of a page header: a height, a color and a style, and in a practical application, may further include other attribute information of the page header, such as an image, a size, etc. Differences in content included in the configuration information can enable the page header to have personalized content (such a page header that is displayed based on configuration information is referred hereinafter as a personalized page header).

In the present embodiment, configuration information can be set up by a user when creating a page header and can be changed during use, or can be automatically adjusted based on content of a current page and a predetermined correspondence relationship. For example, when the page header is displayed according to the configuration information, the configuration information is automatically adjusted as height 1, color 1, and style 1 according to the correspondence relationship when the current page is a page associated with a game. The configuration information is automatically adjusted as height 2, color 2, and style 2 according to the correspondence relationship when the current page is switched to a page associated with a shopping site. The configuration information may further be automatically adjusted based on a domain name to which the current page belongs and a predetermined correspondence relationship. For example, when the current page is a page in a domain name 1, the configuration information is automatically adjusted as height 3, color 3, and style 3 according to the correspondence relationship. When the current page is a page in a domain name 2, the configuration information is automatically adjusted as height 4, color 4, and style 4 according to the correspondence relationship. The page header can be actively changed to match with page content in accordance with different pages and applications according to the correspondence relationship.

In this embodiment, “the current page is in a browsing status” corresponds to the current page being in a browsing status when a page header is to be displayed or the current page being switched to the browsing status from another status.

In an embodiment, the method may further include:

when the current page is the information display page and is in a modal status or in a scrolling status, displaying a page header having a title bar only; and

when the current page is the information detail page and is in an editing status or in the scrolling status, displaying the page header having the title bar only (which is referred hereinafter as a mini header).

In some embodiments, the attribute information of the page header in the configuration information may be set to be the same as one for displaying the mini header. In this case, the mini header is displayed during the browsing status. This is also a possibility for a personalized setting of configuration information. Because the mini header is displayed according to the configuration information, the min header is also a type of personalized page header.

In an embodiment, the method of displaying may further include:

when the current page is the information display page and is in the browsing status, displaying a page header having a navigation function (which is referred hereinafter as a navigation header) if the page header includes a navigation bar.

In this implementation, the navigation function can also be realized when the page is browsed.

In this implementation, when a mini header is to be displayed, a navigation bar is hidden if the navigation bar exists in the page header. If the configuration information exists, personalized content that is set up in the configuration information is hidden, and only a title bar is simply displayed.

Additionally, the method may further include:

when the current page is switched from the browsing status to the modal status, the editing status or the scrolling status, hiding the navigation bar and switching to display a page header having a title bar only if an originally displayed page header includes a navigation function; or if the originally displayed page header has been displayed according to the configuration information, ignoring the configuration information and switching to display the page header having the title bar only;

when the current page is switched to the browsing status from another status and if the current page is the information display page, switching to display a page header having a navigation function if a navigation bar exists, or switching to display a page header according to configuration information if the navigation bar does not exist and the configuration information exists; if the current page is the information detail page, hiding a navigation bar and switching to display a page header according to configuration information if the navigation bar and the configuration information exist, or switching to display a page header according to the configuration information if a navigation bar does not exist and the configuration information exists.

When the current page (regardless of whether it is an information display page or an information detail page) is switched from the browsing status to the modal status, the editing status or the scrolling status, the mini header is displayed. The page header in the browsing status is either a navigation header or a personalized page header. If the original header is a navigation header, a navigation bar is hidden and the page header is switched to display a mini header only. If the original header is a personalized page header that is displayed according to the configuration information, personalized content that is configured by the configuration information is to be ignored and the page header is switched to display a mini header only. When the current page is switched to the browsing status from another status, header that is originally displayed should be a mini header. If the current page is an information display page and a navigation bar exists, a navigation bar is recovered and a navigation header is displayed. If a navigation bar does not exist and configuration information exists, personalized content is recovered, switching to display a personalized page header. The mini header is maintained if both navigation bar and configuration information do not exist. When the current page is an information detail page, a navigation bar is hidden and a personalized page header is to be displayed if the navigation bar and configuration information exist; if a navigation bar does not exist and configuration information exists, a personalized page header is directly switched to be displayed; if no configuration information exists, the mini header is maintained (a navigation bar is hidden if the navigation bar exists).

In some embodiments, size, content and function of a page header are adjusted based on page content according to different statuses (a browsing status, a scrolling status, an editing status, a modal status, etc.) and different scenarios (an information display page, an information detail page). In some applications, an essential function of the page header (e.g., navigation, title, etc.) can be obtained while integrating with the content. Furthermore, these page headers of different statuses can be converted to one another through operations. This enables a page header to change automatically and adapt automatically to a current scenario according to different operation scenarios.

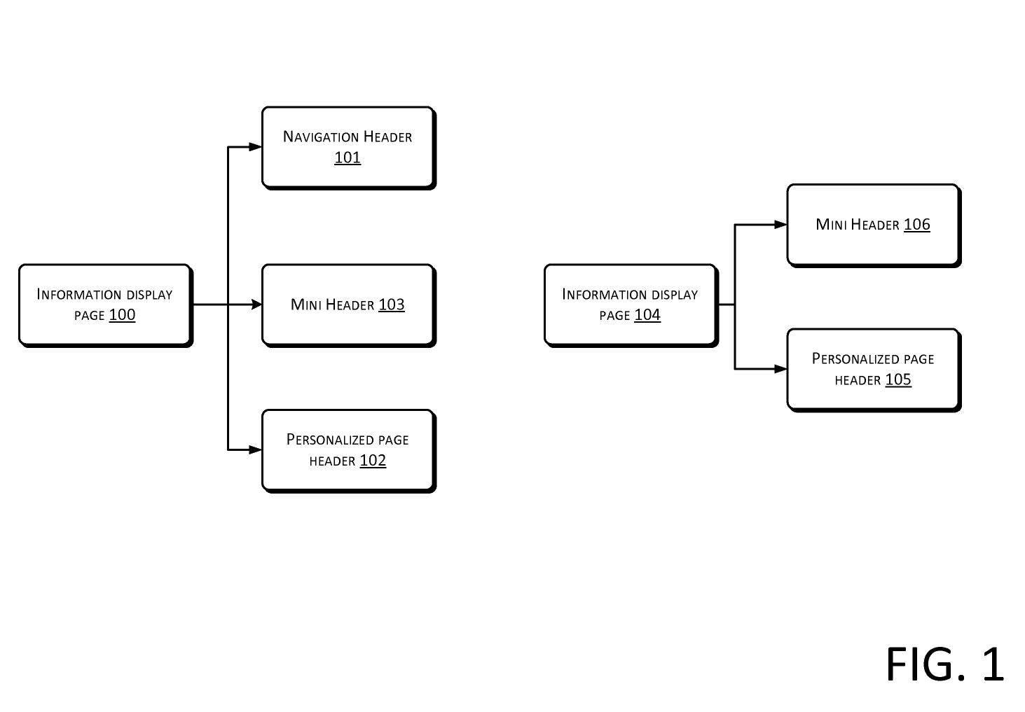

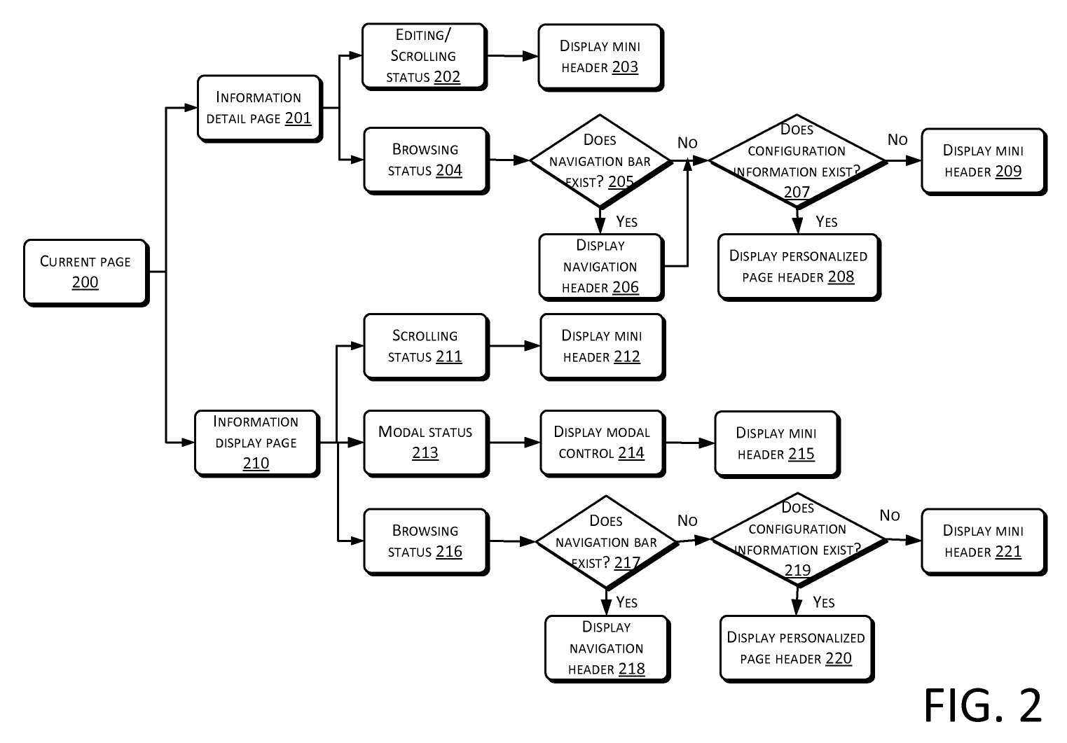

In an embodiment, a page header of an information display page 100 may be one of a navigation header 101, a personalized page header 102 or a mini header 103 as shown in FIG. 1. A page header of an information detail page 104 can only be either a personalized page header 105 or a mini header 106, with details shown in FIG. 2. If a current page 200 is an information detail page 201, a mini header 203 is displayed for an editing status or a scrolling status 202; a navigation bar is hidden 206 for a browsing status 204 if a navigation bar exists 205; personalized content is configured 208 and a personalized page header is displayed 209 if configuration information exists 207; a mini header is displayed if no configuration information exists. If the current page 200 is an information display page 210, a mini header is displayed 212 (configuration information is ignored if the configuration information exists and a navigation bar is hidden if the navigation bar exists) for a scrolling status 211; a modal control is displayed 214 and a mini header is displayed 215 for a modal status 213 (configuration information is ignored if the configuration information exists and a navigation bar is hidden if the navigation bar exists); for a browsing status 216, a navigation header is displayed 218 if the navigation bar exists 217, a personalized page header is displayed 220 if no navigation bar exists and configuration information exists 219, a mini header is displayed 221 if no navigation bar and configuration information exists 219.

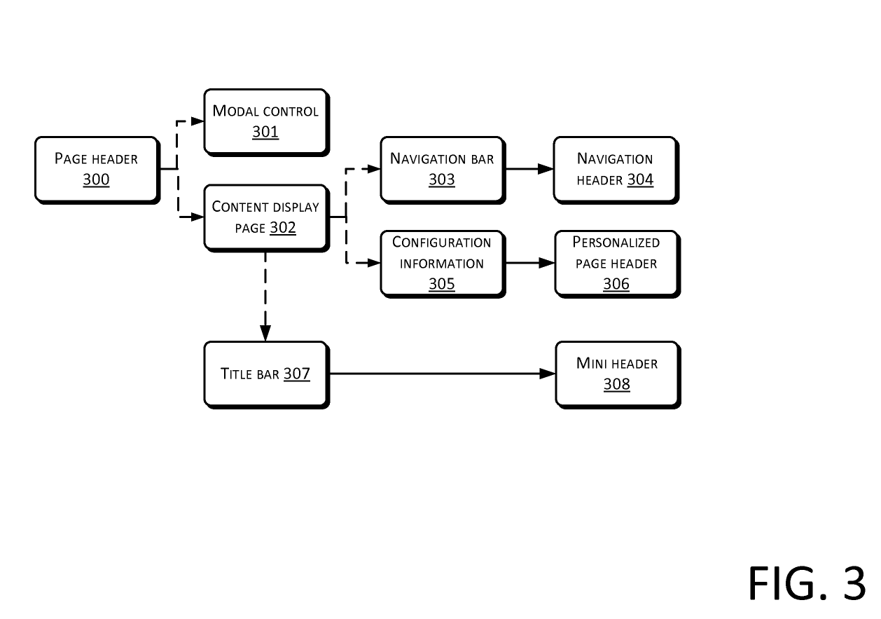

In another example, a page header 300 to be displayed is shown in FIG. 3, and includes a modal control 301 and a content display page 302. Generally, only the content display page 302 is displayed, and the modal control 301 is displayed only when the current page is in a modal status. If the content display page 302 includes a navigation bar 303 and the current page is an information display page in a browsing status, a navigation header 304 is displayed. If the content display page 302 includes configuration information 305 and the current page is an information detail page in a browsing status, a personalized page header 306 is displayed. If the content display page 302 includes configuration information 305 but does not include a navigation bar 303, and the current page is an information display page in a browsing status, a personalized page header 306 is displayed. If the content display page 302 includes a title bar 307 only, a mini header 308 is displayed.

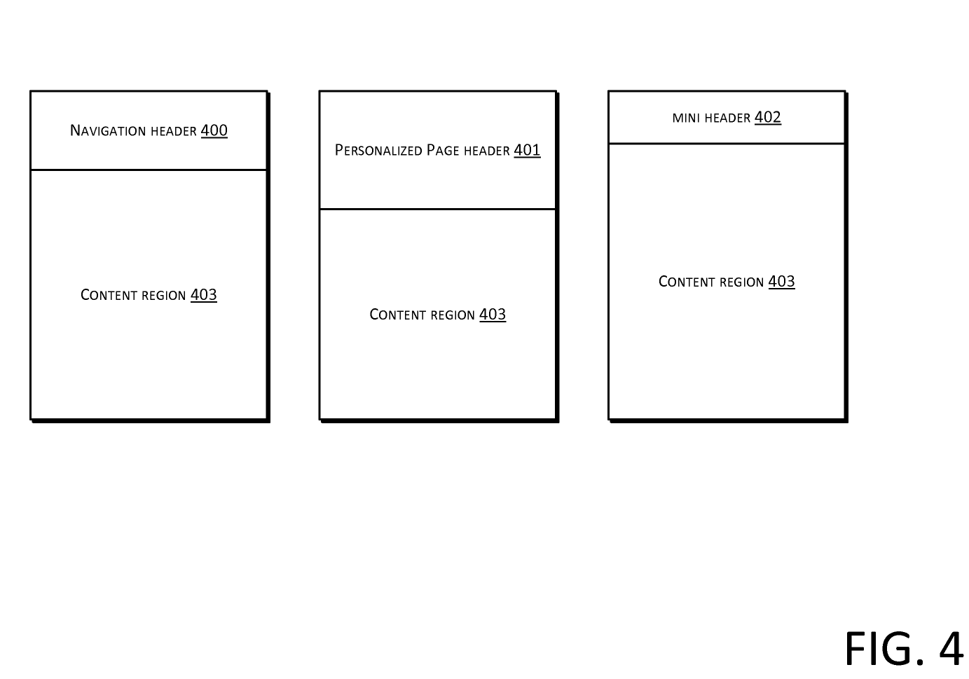

In this example, three forms of page header, as shown in FIG. 4 from left to right, are a navigation header 400, a personalized page header 401 and a mini header 403. A content region 404 may be webpage content or content of an application of a mobile device.

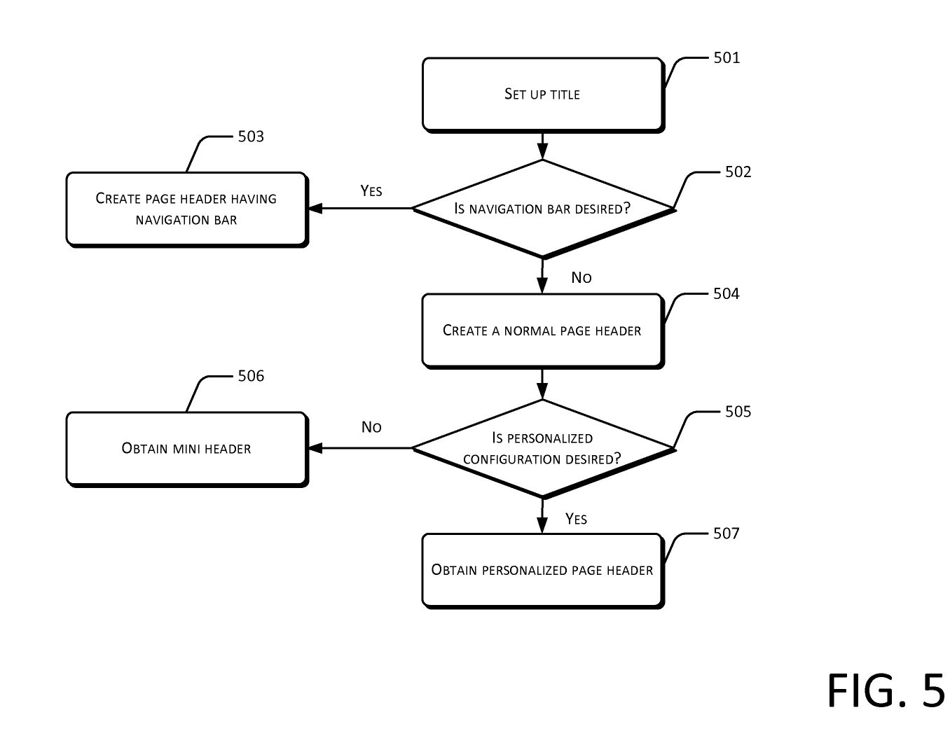

FIG. 5 shows a process of generating a page header in accordance with the first embodiment, and includes blocks 501-507.

Block 501 sets up a title.

Block 502 determines whether a navigation bar is needed, and goes to block 503 if affirmative, or goes to block 504 if the navigation bar is not needed.

Block 503 creates a page header that includes navigation bar to obtain a navigation header. Creation is completed.

Block 504 creates a normal page header.

Block 505 determines whether personalized configuration is needed, and goes to block 506 if not, or goes to block 507 if needed.

Block 506 directly obtains a mini header. Creation is completed.

Block 507 adds configuration information and sets up attribute information of the page header in the configuration information to obtain a personalized page header. Creation is completed.

During display, a navigation bar is hidden if a mini header that is to be displayed is a navigation header; or attribute information of configuration information is ignored if the mini header that is to be displayed is a personalized page header. If a navigation header that is to be displayed is a mini header, a navigation bar is added and displayed. If a navigation header that is to be displayed is a personalized page header, configuration information is ignored, and a navigation bar is added and displayed. Under the circumstance that a personalized page header can be displayed and no configuration information exists, a mini header is displayed.

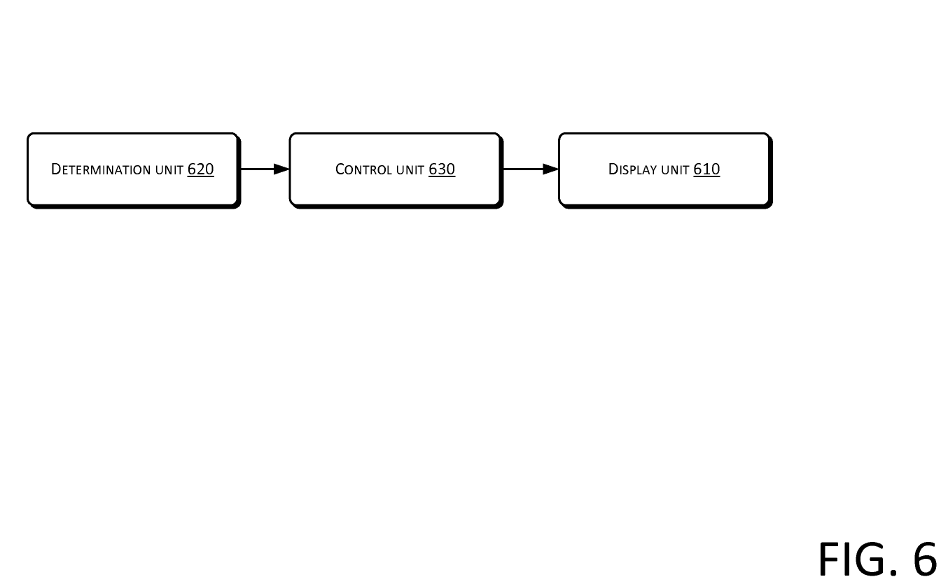

In another embodiment, a client device, as shown in FIG. 6, includes:

a display unit 610,

a determination unit 620 used for, when a page header is to be displayed, determining whether a current page is an information display page or an information detail page, and determining a status of the current page; and

a control unit 630 used for, when the current page is the information display page and is in a browsing status, instructing the display unit 610 to display the page header according to configuration information when the page header does not include a navigation bar; when the current page is the information detail page and is in the browsing status, instructing the display unit 610 to display the page header according to the configuration information.

In some instances, the configuration information includes any one or combination of attribute information of the page header: a height, a color and a style.

In an embodiment, the client device may further include:

a configuration unit for adjusting the configuration information based on content or a domain name of the current page using a predetermined correspondence relationship.

In some embodiments, the control unit 630 is further used for instructing the display unit 610 to display a page header having only a title bar when the current page is the information display page and is in either a modal status or a scrolling status, or when the current page is the information detail page and is in either an editing status or the scrolling status.

Additionally, the control unit 630 is further used for, when the current page is the information display page and is in the browsing status, instructing the display unit 610 to display a page header having a navigation function if the page header includes a navigation bar.

In some embodiments, the control unit 630 is further used for, when the current page is switched from the browsing status to the modal status, the editing status or the scrolling status, hiding a navigation bar and instructing the display unit 610 to switch to display a page header having only a title bar if an originally displayed page header includes a navigation function, or ignoring configuration information and instructing the display unit 610 to switch to display a page header having only a title bar if the originally displayed page header has been displayed according to the configuration information; when the current page is switched to the browsing status from another status, instructing the display unit 610 to switch to display a page header having a navigation function if the current page is the information display page with a navigation bar provided, or instructing the display unit 610 to switch to display a page header according to configuration information if no navigation bar has been provided and the configuration information exists; if the current page is the information detail page, hiding a navigation bar and instructing the display unit 610 to switch to display a page header according to configuration information if the navigation bar and the configuration information exists, and instructing the display unit 610 to switch to display a page header according to the configuration information if no navigation bar has been provided and the configuration information exists.

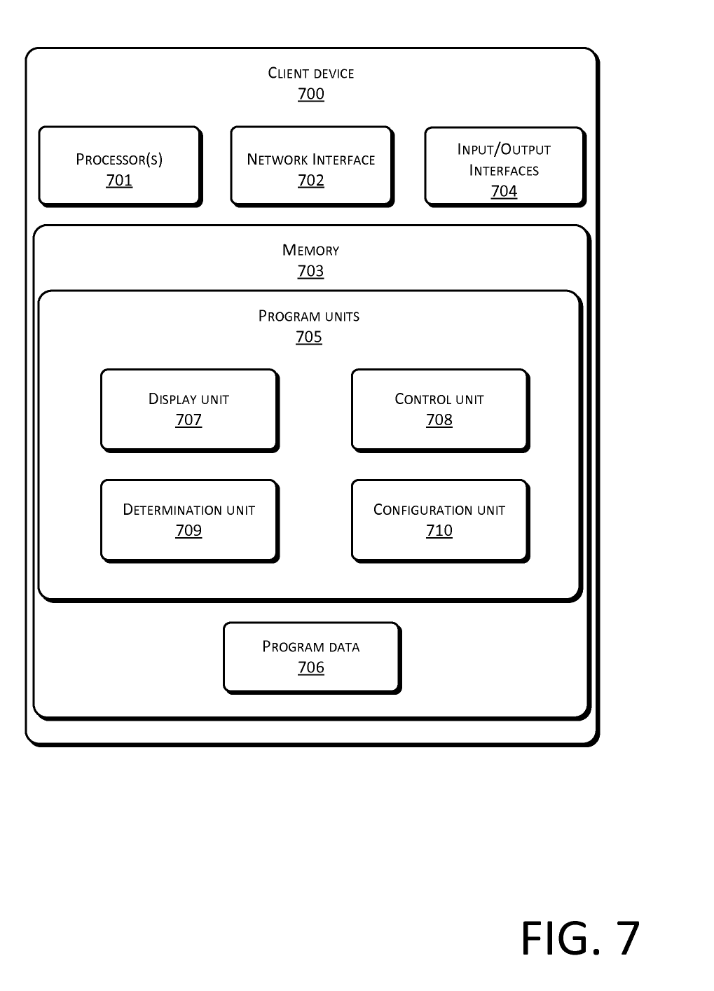

FIG. 7 illustrates an example client device 700, such as the client device as described above, in more detail. In an embodiment, the client device 700 can include, but is not limited to, one or more processors 701, a network interface 702, memory 703, and an input/output interface 704.

The memory 703 may include computer-readable media in the form of volatile memory, such as random-access memory (RAM) and/or non-volatile memory, such as read only memory (ROM) or flash RAM. The memory 703 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 703 may include program units 705 and program data 706. In an embodiment, the program units 705 may include a display unit 707, a control unit 708, a determination unit 709 and a configuration unit 710. Details about these program units may be found in the foregoing embodiments described above.

A person of ordinary skill in the art can understand that that all or part of the foregoing methods can be performed by a program that instructs a relevant hardware component. The program may be stored in a computer-readable storage medium, such as read-only memory, a magnetic disk, or an optical disk. Optionally, all or part of the foregoing embodiments may be implemented using one or more integrated circuits. Accordingly, each module/unit of the foregoing embodiments may be implemented in form of hardware or software functional modules. The present disclosure is not limited to any particular forms of combination of hardware and software.

The present disclosure may also have many other embodiments. A person skilled in the art may make various corresponding changes and modifications based on the present disclosure without departing from the spirit and essence of the present disclosure. However, these corresponding changes and modifications should belong to the scope of protection of the claims of the present disclosure.

What is claimed is:

1. A method for displaying a page header, comprising:
when a page header is to be displayed, determining whether a current page is an information display page or an information detail page, and determining a status of the current page;
when the current page is the information display page and is in a browsing status, displaying the page header according to configuration information if the page header does not include a navigation bar; and
when the current page is the information detail page and is in the browsing status, displaying the page header according to the configuration information.

2. The method as recited in claim 1, wherein the configuration information includes one or more of attribute information of the page header: a height, a color and a style.

3. The method as recited in claim 1, further comprising adjusting the configuration information based on content or a domain name of the current page using a predetermined correspondence relationship.

4. The method as recited in claim 1, further comprising displaying a page header having only a title bar when the current page is the information display page and is in either a modal status or a scrolling status.

5. The method as recited in claim 1, further comprising displaying the page header having only a title bar when the current page is the information detail page and is in either an editing status or a scrolling status.

6. The method as recited in claim 1, further comprising when the current page is the information display page and is in the browsing status, displaying the page header with a navigation function if the page header includes a navigation bar.

7. The method as recited in claim 1, further comprising:
when the current page is switched from the browsing status to a modal status, an editing status or a scrolling status, hiding a navigation bar and switching to display the page header having only a title bar if an originally displayed page header includes a navigation function, or ignoring the configuration information and switching to display the page header having only the title bar if the originally displayed page header has been displayed according to the configuration information.

8. The method as recited in claim 1, further comprising:
when the current page is switched to the browsing status from another status, switching to display the page header having a navigation function if the current page is the information display page with a navigation bar provided, or switching to display the page header according to the configuration information if no navigation bar has been provided and the configuration information exists.

9. The method as recited in claim 1, further comprising: when the current page is switched to the browsing status from another status and if the current page is the information detail page, hiding a navigation bar and switching to display the page header according to the configuration information if the navigation bar and the configuration information exists, and switching to display the page header according to the configuration information if no navigation bar has been provided and the configuration information exists.

10. A client device comprising:
one or more processors;
memory;
a display unit;
a determination unit stored in the memory and executable by the one or more processors that is used for, when a page header is to be displayed, determining whether a current page is an information display page or an information detail page, and determining a status of the current page; and
a control unit stored in the memory and executable by the one or more processors that is used for, when the current page is the information display page and is in a browsing status, instructing the display unit to display the page header according to configuration information when the page header does not include a navigation bar; when the current page is the information detail page and is in the browsing status, instructing the display unit to display the page header according to the configuration information.

11. The client device as recited in 10, wherein the configuration information includes any one or more of attribute information of the page header: a height, a color and a style.

12. The client device as recited in claim 10, further comprising a configuration unit for adjusting the configuration information based on content or a domain name of the current page using a predetermined correspondence relationship.

13. The client device as recited in 10, wherein the control unit is further used for instructing the display unit to display a page header having only a title bar when the current page is the information display page and is in either a modal status or a scrolling status, or when the current page is the information detail page and is in either an editing status or the scrolling status.

14. The client device as recited in claim 10, wherein the control unit is further used for, when the current page is the information display page and is in the browsing status, instructing the display unit to display the page header with a navigation function if the page header includes the navigation bar.

15. The client device as recited in claim 10, wherein the control unit is further used for, when the current page is switched from the browsing status to a modal status, an editing status or a scrolling status, hiding the navigation bar and instructing the display unit to switch to display a page header having only a title bar if an originally displayed page header includes a navigation function, or ignoring the configuration information and instructing the display unit to switch to display the page header having only the title bar if the originally displayed page header has been displayed according to the configuration information.

16. The client device as recited in claim 10, wherein the control unit is further used for, when the current page is switched to the browsing status from another status, instructing the display unit to switch to display a page header with a navigation function if the current page is the information display page with the navigation bar provided, or instructing the display unit to switch to display the page header according to the configuration information if no navigation bar has been provided and the configuration information exists.

17. The client device as recited in claim 10, wherein the control unit is further used for, when the current page is switched to the browsing status from another status and if the current page is the information detail page, hiding the navigation bar and instructing the display unit to switch to display the page header according to the configuration information if the navigation bar and the configuration information exists, and instructing the display unit to switch to display the page header according to the configuration information if no navigation bar has been provided and the configuration information exists.

18. One or more computer-readable media storing executable instructions that, when executed by one or more processors, cause the one or more processors to perform acts comprising:
when a page header is to be displayed, determining whether a current page is an information display page or an information detail page, and determining a status of the current page;
when the current page is the information display page and is in a browsing status, displaying the page header according to configuration information if the page header does not include a navigation bar; and
when the current page is the information detail page and is in the browsing status, displaying the page header according to the configuration information.

19. The one or more computer-readable media as recited claim 18, the acts further comprising adjusting the configuration information based on content or a domain name of the current page using a predetermined correspondence relationship.

20. The one or more computer-readable media as recited in claim 18, the acts further comprising:
when the current page is switched from the browsing status to a modal status, an editing status or a scrolling status, hiding a navigation bar and switching to display a page header having only a title bar if an originally displayed page header includes a navigation function, or ignoring the configuration information and switching to display the page header having only the title bar if the originally displayed page header has been displayed according to the configuration information.
